(19) United States
(12) Patent Application Publication
(10) Pub. No.: US 2005/0253917 A1
(43) Pub. Date: Nov. 17, 2005

(54) Method for forming color filters in flat panel displays by inkjetting

(76) Inventors: Quanyuan Shang, Saratoga, CA (US); Fan Cheung Sze, San Jose, CA (US); John White, Hayward, CA (US)

Correspondence Address: MOSER, PATTERSON & SHERIDAN, LLP;APPLIED MATERIALS, INC., 3040 POST OAK BOULEVARD, SUITE 1500, HOUSTON, TX, 77056, US

(21) Appl. No.: 10/845,629

(22) Filed: May 13, 2004

(51) Int. Cl. B41M 5/20

(52) U.S. Cl. 347/107

(57) ABSTRACT

A method for forming color filters for flat panel displays comprising dispensing color inks into a pre-patterned matrix using an inkjet device and curing the dispensed color inks. In one aspect, the color inks are cured in a concave configuration. In another aspect, the color inks are cured using electron beam, laser, X-ray, or other suitable high energy source.

### BACKGROUND OF THE INVENTION

1. Field of the Invention

Embodiments of the invention generally relate to flat panel displays and particularly to methods for forming color filters for use in flat panel displays.

2. Description of the Related Art

Flat panel displays (FPDs) have become the display technology of choice for computer terminals, visual entertainment systems, and personal electronic devices such as cellular phones, personal digital assistants (PDAs), and the like. Liquid crystal displays (LCDs), and especially active matrix liquid crystal displays (AMLCDs), have emerged as the most versatile and robust of the commercially available FPDs. A basic element of the LCD technology is a color filter through which light is directed to produce a colored visual output. The color filter is made up of pixels, which are typically red, green, and blue and are distributed in a pattern or array within an opaque (black) matrix which allows for improved resolution of the color filtered light.

Traditional methods of producing these color filters, such as dyeing, lithography, pigment dispersion, and electrodeposition, all have a major disadvantage of requiring the sequential introduction of the three colors. That is, a first set of pixels having one color is produced by a series of steps, whereupon the process must be repeated twice more to apply all three colors. The series of steps involved in this process includes at least one curing phase in which the deposited liquid color agent must be transformed into a solid, permanent form.

A possible area for improvement in the technology applicable to color filter production has been the introduction of improved dispensing devices, such as inkjets. By using an inkjet system, all three colors can be applied within the color filter matrix in one step and hence the process need not be carried out in triplicate.

While use of inkjets potentially simplifies the production of color filters, the inkjet systems currently in use have drawbacks. Presently used color agent formulations are prone to premature curing. That is, they tend to degrade and thicken prior to dispensing into the matrix. This degradation of the color agent formulation has a yellowing effect on pixels produced therefrom and thickening tends to cause clogging of the inkjet nozzle during processing.

Another challenge arising in utilization of inkjet technology is the dispensing of the color agent formulation into a pixel well without spilling over into the neighboring pixels. Inkjetting into conventional matrices tends to result in mixing of the different color agents, which produces lesser quality color filters. This limitation in maintaining color agent homogeneity within the pixels, coupled with the abovementioned problem of premature curing, has made inkjet technology difficult to implement in the production of color filters.

Therefore, a need exists to develop an improved method for forming color filters by an inkjet method whereby the color agent formulation is stable during storage and processing providing longer shelf life and improved flowability. In addition, an improved pre-patterned matrix is needed to insure high quality color pixels are produced.

### SUMMARY OF THE INVENTION

The present invention provides a method for forming color filters and the filters produced therefrom. In one embodiment, the method for forming color filters comprises a process wherein a pre-patterned matrix is disposed on a substrate. Color inks that are curable by an energy source, such as an electron beam, are dispensed into the matrix utilizing an inkjet device. In another embodiment, a color filter is produced containing color pixels in which the cured color inks form a concave surface.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side-view of a pre-patterned matrix of one embodiment of the invention.

FIG. 2 is a side-view of pixels in a color filter in which the color inks are disposed within the pre-patterned matrix in a concave configuration.

FIG. 3 is a block diagram showing one embodiment of the apparatus of the claimed invention.

### DETAILED DESCRIPTION OF THE PREFERRED EMBODIMENT

One embodiment of the invention includes a method for forming a color filter by forming a pre-patterned matrix on a substrate, utilizing an inkjet device to dispense color inks, and curing the dispensed color inks in a concave configuration. In another aspect of the invention, the method for forming a color filter includes forming a pre-patterned matrix on a substrate, utilizing an inkjet device to dispense color inks, and curing the dispensed color inks with an electron beam. In another embodiment, the invention includes forming a pre-patterned matrix on a substrate, utilizing an inkjet device to dispense color inks, and curing the dispensed color inks in a concave configuration with a high energy source. Embodiments of the invention further encompass color filters produced from processes of the inventions.

The substrates upon which the pre-patterned matrix is formed can be any material having a high degree of optical transparency such as, for example, glass. Additionally, the substrate may be coated or otherwise contain a treated surface to assist in adherence of the materials to be applied thereupon.

Various embodiments entail dispensing color inks into a pre-patterned matrix formed on the substrate. Suitable pre-patterned matrices would include, but are not limited to, a resin matrix and a chromium matrix. The matrix is typically formed by coating the substrate with a resin or depositing a non-reflective metal such as chromium thereupon and then patterning the matrix material using a photolithographic process. Resinous materials commonly used in forming black matrices comprise a low transmittance, black component, such as carbon black or an organic pigment, that is dispersed in an acrylic or polyimide resin. The matrix fabricated in the practice of this embodiment has a height of preferably about 10,000-25,000 Å, but in any event, greater than the desired thickness of the color inks to be dispensed therein, and preferably 10-100% higher than the required color ink thickness. This matrix geometry also assists in minimizing any spillover of ink from one pixel to another during dispensing. Obtaining sufficient black matrix height is not an issue when a resin process is utilized. However; chromium layers are typically deposited with a thickness of only about 500-1000 Å. This limitation is circumvented by applying a layer of photoresist before the chromium is patterned, and the requisite matrix height is attainable by leaving the necessary thickness of resist disposed thereon after patterning. By not having to remove the residual resist after patterning of the chromium, an additional step in the processing sequence can be eliminated.

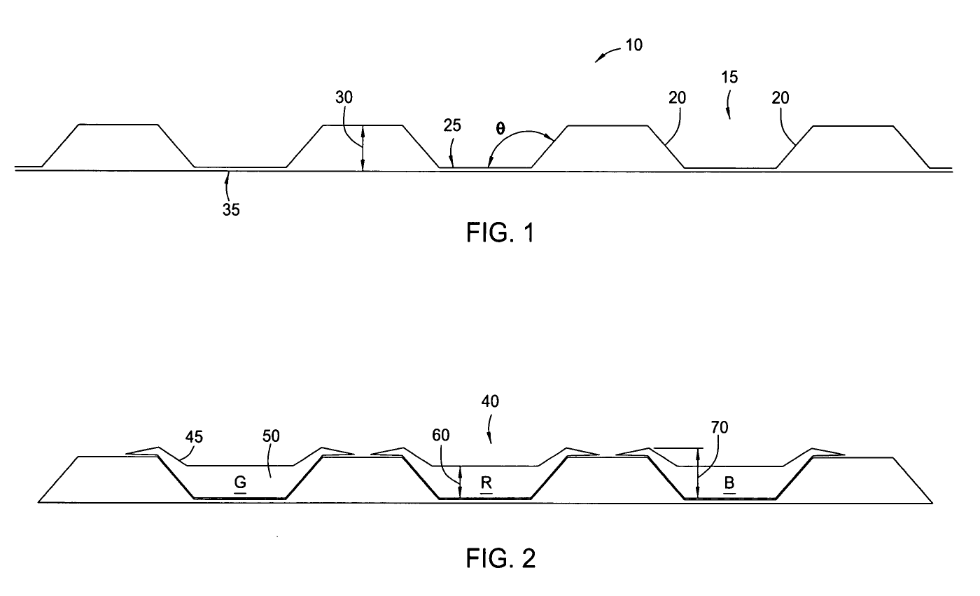

FIG. 1 is a two-dimensional side-view of a pre-patterned matrix 10 disposed on substrate 35. Pre-patterned matrix 10 contains wells 15 defined by the void delineated by matrix well walls 20 and well bottoms 25. The angle θ as depicted in FIG. 1 describes the slant of well walls 20 in relation to well bottoms 25. The slant angle θ described in FIG. 1 is greater than 90 degrees, however, a matrix having well walls 20 defining an angle θ of less than 90 degrees may also be used to advantage, as the concave configuration 45 assumed by color inks 50 upon introduction into the pre-patterned matrix 10 (see FIG. 2) is not wholly dependent on the magnitude of the angle θ. The surface of pre-patterned matrix 10, which includes well walls 20 and well bottoms 25, is preferentially formed with a wettability that facilitates adherence of the dispensed color inks 50 thereto, thereby assisting in orientation of the cured color inks 50 in a concave configuration 45, as shown in FIG. 2.

It has been found that superior color filtration is achieved by a color filter wherein the color inks assume a concave shape, i.e., the periphery is elevated above the center, instead of a flat or convex surface orientation within the black matrix. Not to be bound by theory, the benefits are believed to result from a decrease in light scattering, thereby sharpening the focusing of the filtered light. In order to produce such a configuration, a pre-patterned matrix into which the color inks are introduced has a height greater than the center thickness of the cured color inks and allows for adhesion of the color inks to the surface thereof.

Proper wettability to improve adhesion of the dispensed color inks can be achieved by producing a matrix surface with an ink affinity. This can be accomplished when a chromium matrix is employed by choice of a suitable photoresist substrate, or by treating a residual photoresist by, for example, implementing a plasma oxygen treatment. The activated oxygen species and attendant ion bombardment modify the photoresist surface wettability so that the color filter may possess the concave configuration.

FIG. 2 is a two-dimensional side-view of pixels 40 disposed in pre-patterned matrix 10. Pixels 40 encompass wells 15 into which color inks 50 have been dispensed. FIG. 2 shows the concave configuration 45 of pixels 40 wherein the thickness 70 of the dispensed color inks 50 at the periphery thereof is greater than the thickness 60 at the center surface thereof. Importantly, the thickness 70 of the dispensed color inks 50 is greater than the height 30 of the pre-patterned matrix 10. This height differential assists in formation of the concave configuration 45 shown in FIG. 2.

The color agent formulations employed herein comprise a mixture of materials including, but not limited to, color pigments and dyes, solvents, additives, acrylic monomers, acrylic and/or methacrylic oligomers, and optionally, a photoinitiator. Herein, a color agent formulation is defined as a color resist if the formulation includes one or more photoinitiators for UV lithographic patterning, and is defined as an ink or color ink if the formulation does not contain any photoinitiators. Although the present invention admits to embodiments utilizing either color inks or color resists, for simplicity the description of the various aspects is directed to inks.

The pigments and/or dyes which serve as the color agents are dispersed in the ink mixtures in proportions up to about thirty percent, and include substances generally known within the relevant art as suitable for forming red, green, and blue color filter pixels, such as, but not limited to, C.I Pigment Red 177, C.I. Pigment Green 36, and C.I. Pigment Blue 15:6. An alternative color system using Cyan, Yellow, Magenta and (optionally) White, can also be used.

The solvent or solvent mixture present in each color ink serves a twofold purpose. First, it solubilizes the other constituents of the color ink, thereby allowing for formulation of a color ink with optimal flowability for dispensing by the inkjet device. Second, by its evaporation during the inkjetting process it allows for concentrating of the color ink on the surface of the matrix, thereby promoting adhesion of the color agent within the matrix in the desired configuration. Therefore, the solvent or solvent mixture must be capable of dissolving the other color ink components and it must possess a volatility sufficient to create the required thickening of the color ink upon complete or partial evaporation thereof during processing. Suitable solvents include, but are not limited to, 3-methoxybutyl acetate, methoxy propanolacetate, ethoxyethylpropionate, propyleneglycol monomethylether acetate, and combinations thereof.

Any additives contained in the color ink assist in effectuating a liquid material with the desired properties, including but not limited to, solubility, viscosity, and surface tension. Some common types of additives so employed include, but are not limited to, surfactants, oxidizers, and anti-foaming agents.

The acrylic monomers and/or acrylic or methacrylic oligomers contained in the inks undergo free-radical polymerization upon application of certain forms and quanta of energy. The polymerizate thus formed comprises a solid material which fixes the color agent within the matrix. As previously described, polymerization initiated before dispensing of the color agent formulations (premature curing) is a problem with the currently known technologies. Color resists are UV curable and are prone to premature curing during storage and use from exposure to background light. In addition, color agent formulations that are curable by introduction of low level thermal energy, (hereinafter “thermal cure inks”), are similarly subject to premature curing during storage and use which results from exposure to ambient temperatures. While a traditional UV color resist or thermal cure color ink may be employed in practicing embodiments of the invention, preferred embodiments of the invention utilize another energy source to initiate the polymerization. The energy source selected to effect the polymerization bestows advantages in various embodiments.

It is a particular advantage of certain embodiments that they utilize color inks in which the reactive moieties remain intact during storage and processing until their polymerization is desired. As premature curing causes the aforementioned problems of pixel yellowing and nozzle clogging, the color inks disclosed herein negate the need for inclusion of a photoinitiator and require an energy source for polymerization that does not generally exist as a background environmental element, such as ambient light and heat. High energy sources which may be utilized include, but are not limited to, energy sources such as electron beam, laser, and X-ray.

A suitable electron beam source includes, but is not limited to, an electron gun as disclosed in commonly assigned U.S. patent application Ser. No. 10/055,869, which was filed on Jan. 22, 2002 under the title “Electron Beam Lithography System Having Improved Electron Gun,” which is incorporated by reference herein in its entirety, to the extent it is not inconsistent herewith. Examples of chemical substituents which may serve as effective electron beam crosslinking substituents suitable for inclusion in the monomers and/or oligomers contained in the color ink include, but are not limited to, (a) carbon-carbon double bonds (for example, an alkene functionality built into or attached onto a pendent group, such as an adamantyl cage) or attached either to the pendant group or a polymer; (b) “strained” ring systems such as, for example, and without limitation, three (3) or four (4) member cycloalkanes prone to ring opening and cross-linking upon exposure to electron beam irradiation; (c) halogenated compounds such as for example, a halomethyl substituent prone to cross-linking under electron beam irradiation through processes correlated with the extrusion of a hydrogen halide (such as, for example, HCl); and (d) one or more organo-silicon moieties, which are more particularly described in commonly assigned U.S. patent application Ser. No. 10/447,729, which was filed on May 28, 2003 under the title “E-Beam Curable Resist And Process For E-Beam Curing The Resist,” which is incorporated by reference herein in its entirety, to the extent it is not inconsistent herewith.

As used herein, the term electron beam, or e-beam, treatment refers to exposure of a film to a beam of electrons, for example, and without limitation, a relatively uniform beam of electrons. As used herein, the term electron beam source, or electron beam emitter, or e-beam emitter refers to a device capable of producing an electron beam. It is preferred that the e-beam treatment step be conducted using a wide, large beam of electron radiation from a uniform, large-area electron beam source that simultaneously covers the entire substrate area. In a production environment where the substrate size is larger than the broad e-beam source, the color filters are scanned by the electron beam emitter in a manner to achieve an uniform exposure of electron beam. Preferably, the e-beam treatment should be conducted at, but is not limited to, atmospheric pressure. A suitable electron beam chamber is one such as the ElectronCure™ chamber that is available from Applied Materials, Inc. of Santa Clara, Calif. The principles of operation and performance characteristics of such an apparatus are described in commonly assigned U.S. Pat. No. 5,003,178, which is incorporated by reference herein in its entirety, to the extent it is not inconsistent herewith. The electron beam energy is in a range from about 1 to about 200 KeV, depending on processing pressure and conditions. The total dose of electrons for the polymerization of the color filters is adjusted according to the type and thickness of color filters, chamber or enclosure conditions, speed of substrate movement, and e-beam energy.

The gas ambient in the electron beam chamber can include, but is not limited to, nitrogen, oxygen, hydrogen, argon, xenon, helium, carbon dioxide, or any combination of two or more of these gases. The e-beam treatment is preferably conducted at atmospheric pressure. When a vacuum chamber is employed, the vacuum conditions are maintained at a pressure of from just below atmospheric pressure down to about 10⁻⁷ Torr. The temperature of the substrate may vary in a range from about 20° C. to about 200° C. Preferably, the temperature is controlled in the range from 20° C. to 80° C. In addition, for thick films, the electron beam dose may be divided into steps of decreasing voltage which provides a uniform dose process in which the material is cured from the bottom up. Thus, the depth of electron beam penetration may be varied during the treatment process. As those of ordinary skill in the art can readily appreciate, the length of e-beam treatment may depend on one or more of the above-identified parameters, and that particular sets of parameters can be determined routinely without undue experimentation in light of the detailed description presented herein.

An inkjet device for dispensing the color inks in the present invention includes, but is not limited to, a piezoelectric inkjet printing apparatus. Generally, a suitable inkjet device includes any apparatus that contains one or more arrays of nozzles that are capable of dispensing different colors of inks such as Red, Green, Blue and (optionally) White. An alternative color system using Cyan, Yellow, Magenta and (optionally) White, can also be used. The color inks can be dispensed onto the substrate one color ink at a time or multiple color inks may be dispensed at the same time.

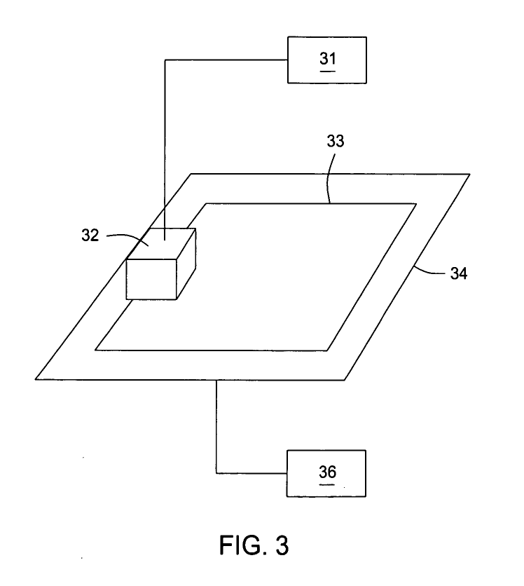

FIG. 3 depicts various aspects of an apparatus suitable for practicing embodiments of the present invention. An inkjet head assembly 32 is located above a stage 34 upon which is supported a substrate 33. The inkjet head assembly 32 comprises one or more arrays of one or more nozzles (not shown). The number of arrays would typically correspond to the number of different color inks employed. A first motor 31 is controllably connected to the inkjet head assembly 32 allowing for movement thereof relative to the substrate 33. A second motor 36 is controllably connected to the stage 34 allowing for movement of the substrate relative to the inkjet head assembly 32. The inkjet head assembly 32 and stage 34 are independently movable and either or both may be moved during processing. In one embodiment, the inkjet head assembly 32 comprises a self contained means (not shown) for storing the inks and delivering the inks to the nozzles during processing. In a separate embodiment, the inks are delivered to the inkjet head assembly 32 continuously during processing by a means (not shown) of tubing or other suitable plumbing arrangement. While this diagram describes one suitable apparatus for forming color filters according to the claimed invention, other inkjet devices and orientations thereof may also be used to advantage.

In one embodiment, C.I Pigment Red 177, C.I. Pigment Green 36, and C.I. Pigment Blue 15:6 were used to formulate the color inks, while acrylic monomers and oligomers were utilized as polymerization precursors, and propyleneglycol monomethylether acetate was employed as the solvent. The proportions of the ink components are preferably in the range of 10-30% dyes or pigments, 20-60% monomers and/or oligomers, and 30-50% solvent(s).

In a further embodiment, an inkjet device of the type containing arrays of nozzles was used to dispense inks in a pre-patterned matrix, wherein the inks consisted of C.I Pigment Red 177, C.I. Pigment Green 36, and C.I. Pigment Blue 15:6, and the matrix consisted of a black resin. The dispensed inks were cured using electron beam.

While the foregoing is directed to embodiments of the present invention, other and further embodiments of the invention may be devised without departing from the basic scope thereof, and the scope thereof is determined by the claims that follow.

1. A method for forming color filters for flat panel displays, comprising:
dispensing color inks into a pre-patterned matrix using an inkjet device, and
curing the dispensed color inks, whereby the cured color inks have a concave configuration.

2. The method of claim 1, wherein each color ink comprises:
one or more color pigments and/or dyes,
one or more monomers and/or oligomers for forming a polymer matrix, and
one or more solvents.

3. The method of claim 1, wherein the colors of the color inks are selected from the group consisting of:
red, green and blue,
red, green, blue and white,
cyan, yellow and magenta, and
cyan, yellow, magenta and white.

4. The method of claim 1, wherein each color ink comprises:
10-30% color pigments and/or dyes,
20-60% monomers and/or oligomers, and
30-50% solvents.

5. The method of claim 2, wherein each color ink further comprises one or more photoinitiators.

6. The method of claim 2, wherein the one or more solvents are selected from the group consisting of:
3-methoxybutyl acetate,
methoxy propanolacetate,
ethoxyethylpropionate,
propyleneglycol monomethylether acetate, and
combinations thereof.

7. The method of claim 1, wherein the pre-patterned matrix comprises a resin black matrix.

8. The method of claim 1, wherein the pre-patterned matrix comprises a chromium black matrix.

9. The method of claim 1, wherein the pre-patterned matrix has a height of about 10,000-25,000 Å.

10. The method of claim 1, wherein the pre-patterned matrix has a height greater than a center thickness of the cured color inks.

11. The method of claim 1, wherein the inkjet device comprises one or more arrays of one or more nozzles.

12. The method of claim 1, wherein the dispensed color inks are cured using UV radiation.

13. The method of claim 1, wherein the dispensed color inks are cured using electron beam, laser, or X-ray.

14. A method for forming color filters for flat panel displays comprising:
dispensing color inks into a pre-patterned matrix using an inkjet device; and
curing the dispensed color inks, wherein the curing is accomplished by use of an electron beam energy source.

15. The method of claim 14 wherein the color inks comprise materials selected from the group consisting of:
one or more color pigments and/or dyes,
one or more monomers and/or oligomers for forming a polymer matrix, and
one or more solvents.

16. The method of claim 14 wherein the pre-patterned matrix comprises a resin black matrix.

17. The method of claim 14 wherein the pre-patterned matrix comprises a chromium black matrix.

18. The method of claim 14, wherein the pre-patterned matrix has a height of about 10,000-25,000 Å.

19. The method of claim 14 wherein the pre-patterned matrix has a height greater than a center thickness of the cured color inks.

20. A method for forming color filters for flat panel displays comprising:
dispensing color inks into a pre-patterned matrix using an inkjet device, whereby the color inks have a concave configuration; and
curing the dispensed color inks, wherein the curing is accomplished by use of a high energy source.

21. The method of claim 20 wherein the high energy source is selected from the group consisting of:
electron beam,
laser, and
X-ray.

22. A color filter produced by a process comprising:
dispensing color inks into a pre-patterned matrix using an inkjet device, whereby the dispensed color inks have a concave configuration, and
curing the dispensed color inks.

23. A color filter produced by a process comprising:
dispensing color inks into a pre-patterned matrix using an inkjet device, and
curing the dispensed color inks, wherein the curing is accomplished by use of a high energy source.

24. The color filter of claim 23, wherein:
A) the dispensed color inks have a concave configuration; and
B) curing is accomplished by use of a high energy source selected from the group consisting of:
electron beam,
laser, and
X-ray.
